(19) United States
(12) Patent Application Publication
(10) Pub. No.: US 2025/0273181 A1
(43) Pub. Date: Aug. 28, 2025

(54) DISPLAY DEVICE PERFORMING IMAGE STICKING COMPENSATION, METHOD OF COMPENSATING IMAGE STICKING IN THE DISPLAY DEVICE, AND AN ELECTRONIC DEVICE INCLUDING THE DISPLAY DEVICE

(71) Applicant: Samsung Display Co., LTD., Yongin-si (KR)

(72) Inventors: GI-NA YOO, Yongin-si (KR); BUM-KYUN CHOI, Yongin-si (KR)

(21) Appl. No.: 19/002,382

(22) Filed: Dec. 26, 2024

(30) Foreign Application Priority Data
Feb. 27, 2024 (KR) 10-2024-0027927

(51) Int. Cl. G09G 5/02

(52) U.S. Cl. CPC G09G 5/02; G09G 2320/0242; G09G 2320/0666; G09G 2360/144

(57) ABSTRACT

A display device includes: a display panel including a plurality of pixels; an ambient light sensor configured to sense an ambient light of the display panel; and an image sticking compensator configured to perform an image sticking compensation operation on the pixels. The image sticking compensator includes an accumulation lookup table configured to generate a wavelength spectrum of an accumulated deterioration amount of the pixels based on the accumulated deterioration amount of the pixels; and a compensation lookup table configured to generate a compensation value of the pixels for compensating an input image data based on a wavelength spectrum of the ambient light and the wavelength spectrum of the accumulated deterioration amount. An ambient light lookup table included in the image sticking compensator or the ambient light sensor is configured to generate the wavelength spectrum of the ambient light based on the ambient light of the display panel.

This application claims priority to Korean Patent Application No. 10-2024-0027927, filed on Feb. 27, 2024, and all the benefits accruing therefrom under 35 U.S.C. § 119, the content of which in its entirety is herein incorporated by reference.

### BACKGROUND

### 1. Field

Embodiments of the present invention relates to a display device. More particularly, the present invention relates to a display device performing an image sticking compensation, and a method of compensating an image sticking in the display device, and an electronic device including the display device.

### 2. Description of the Related Art

In general, a display device includes a display panel and a display panel driver. The display panel driver drives the display panel. The display panel includes a plurality of pixels and displays an image using the pixels.

The pixels may deteriorate with use, and an image sticking may be perceived on the display panel according to the accumulated deterioration amount of the pixels. Therefore, the display panel driver may compensate for input image data based on the accumulated deterioration amount of the pixels.

However, when ambient light is illuminated on the display panel, the luminance and color of the image perceived by the user may vary depending on the ambient light of the display panel. Therefore, even if the input image data is compensated based on the accumulated deterioration amount of the pixels, the luminance and color of the image displayed by the display panel may not be accurate.

### SUMMARY

Embodiments of the present invention provide a display device for performing an image sticking compensation operation which accurately expresses a luminance and a color of an image perceived by a user.

Embodiments of the present invention provide a method of compensating an image sticking in the display device.

Embodiments of the present invention provide an electronic device including the display device.

In an embodiment of a display device according to the present invention, the display device includes: a display panel including a plurality of pixels, an ambient light sensor configured to sense an ambient light of the display panel, and an image sticking compensator configured to perform an image sticking compensation operation on the pixels. The image sticking compensator includes an accumulation lookup table configured to generate a wavelength spectrum of ab accumulated deterioration amount of the pixels based on the accumulated deterioration amount of the pixels, and a compensation lookup table configured to generate a compensation value of the pixels for compensating an input image data based on a wavelength spectrum of the ambient light and the wavelength spectrum of the accumulated deterioration amount, where an ambient light lookup table included in the image sticking compensator or the ambient light sensor is configured to generate the wavelength spectrum of the ambient light based on the ambient light of the display panel.

In an embodiment, the image sticking compensator may further include an accumulation memory configured to store the accumulated deterioration amount of the pixels.

In an embodiment, the image sticking compensator may further include a compensation memory configured to store the compensation value and a data compensator configured to compensate the input image data based on the compensation value.

In an embodiment, the ambient light may include a red ambient light, a green ambient light, and a blue ambient light, and the ambient light sensor may be configured to sense the ambient light to generate an intensity of the red ambient light, an intensity of the green ambient light, and an intensity of the blue ambient light and provide the intensity of the red ambient light, the intensity of the green ambient light, and the intensity of the blue ambient light to the ambient light lookup table.

In an embodiment, the ambient light lookup table may generate the wavelength spectrum of the ambient light based on the intensity of the red ambient light, the intensity of the green ambient light, and the intensity of the blue ambient light.

In an embodiment, each of the pixels may include a red sub-pixel, a green sub-pixel, and a blue sub-pixel, and the accumulated deterioration amount may include a red accumulated deterioration amount which is an accumulated deterioration amount of the red sub-pixel, a green accumulated deterioration amount which is an accumulated deterioration amount of the green sub-pixel, and a blue accumulated deterioration amount which is an accumulated deterioration amount of the blue sub-pixel.

In an embodiment, the accumulation lookup table may generate the wavelength spectrum of the accumulated deterioration amount based on the red accumulated deterioration amount, the green accumulated deterioration amount, and the blue accumulated deterioration amount.

In an embodiment, the compensation lookup table may generate a wavelength spectrum of an image perceived by a user by applying the wavelength spectrum of the ambient light to the wavelength spectrum of the accumulated deterioration amount.

In an embodiment, the compensation lookup table may compare the wavelength spectrum of the image perceived by the user with a reference wavelength spectrum, which is a target wavelength spectrum of the image to be perceived by the user, to generate a final accumulated deterioration amount of the pixels, and generate the compensation value of the pixels based on the final accumulated deterioration amount.

In an embodiment, the ambient light sensor may be an illuminance sensor.

In an embodiment, the ambient light sensor may be an RGB spectrum sensor, generate the wavelength spectrum of the ambient light based on the ambient light of the display panel.

In an embodiment, each of the pixels may include a plurality of cells, and the input image data may be additionally compensated according to a characteristics of each of the cells.

In an embodiment of a method of compensating an image sticking in a display device according to the present invention, the method includes sensing an ambient light of a display panel including a plurality of pixels, generating a wavelength spectrum of the ambient light based on the ambient light of the display panel, generating a wavelength spectrum of an accumulated deterioration amount of the pixels based on the accumulated deterioration amount of the pixels, and generating a compensation value of the pixels based on the wavelength spectrum of the ambient light and the wavelength spectrum of the accumulated deterioration amount.

In an embodiment, the method may further include compensating an input image data based on the compensation value.

In an embodiment, the ambient light may include a red ambient light, a green ambient light, and a blue ambient light. The sensing of the ambient light may include generating an intensity of the red ambient light, an intensity of the green ambient light, and an intensity of the blue ambient light.

In an embodiment, the generating of the wavelength spectrum of the ambient light may be performed based on the intensity of the red ambient light, the intensity of the green ambient light, and the intensity of the blue ambient light.

In an embodiment, each of the pixels may include a red sub-pixel, a green sub-pixel, and a blue sub-pixel. The accumulated deterioration amount may include a red accumulated deterioration amount which is an accumulated deterioration amount of the red sub-pixel, a green accumulated deterioration amount which is an accumulated deterioration amount of the green sub-pixel, and a blue accumulated deterioration amount which is an accumulated deterioration amount of the blue sub-pixel.

In an embodiment, the generating of the wavelength spectrum of the accumulated deterioration amount may be performed based on the red accumulated deterioration amount, the green accumulated deterioration amount, and the blue accumulated deterioration amount.

In an embodiment, the generating of the compensation value may include generating a wavelength spectrum of an image perceived by a user by applying the wavelength spectrum of the ambient light to the wavelength spectrum of the accumulated deterioration amount.

In an embodiment, the generating of the compensation value further include: comparing the wavelength spectrum of the image perceived by the user with a reference wavelength spectrum, which is a target wavelength spectrum of the image to be perceived by the user, to generate a final accumulated deterioration amount of the pixels; and generating the compensation value of the pixels based on the final accumulated deterioration amount.

In an embodiment of an electronic device including a display device, the electronic device comprises a display panel including a plurality of pixels, an ambient light sensor configured to sense an ambient light of the display panel, an image sticking compensator configured to perform an image sticking compensation operation on the pixels, and a power supply configured to provide a power to the display panel, the ambient light sensor, and the image sticking compensator. The image sticking compensator includes an accumulation lookup table configured to generate a wavelength spectrum of ab accumulated deterioration amount of the pixels based on the accumulated deterioration amount of the pixels, and a compensation lookup table configured to generate a compensation value of the pixels for compensating an input image data based on a wavelength spectrum of the ambient light and the wavelength spectrum of the accumulated deterioration amount, where an ambient light lookup table included in the image sticking compensator or the ambient light sensor is configured to generate the wavelength spectrum of the ambient light based on the ambient light of the display panel.

According to the display device, the method, and the electronic device, the input image data may be compensated based on the wavelength spectrum of the ambient light and the wavelength spectrum of the accumulated deterioration amount. Accordingly, the input image data may be effectively compensated considering the luminance and the color of the image perceived by the user.

### BRIEF DESCRIPTION OF THE DRAWINGS

The above and other features of embodiments of the present invention will become more apparent by describing in detailed embodiments thereof with reference to the accompanying drawings, in which:

FIG. 1 is a block diagram illustrating a display device according to embodiments of the present invention;

FIG. 2 is a block diagram illustrating an example of an ambient light sensor and an image sticking compensator of FIG. 1;

FIG. 3 is a graph illustrating a wavelength spectrum of an ambient light;

FIG. 4 is a graph illustrating wavelength spectrums of a red light, a green light, and a blue light expressed by pixels;

FIG. 5 is a graph illustrating a wavelength spectrum of a mixed light expressed by non-deteriorated pixels and a graph illustrating a wavelength spectrum of a mixed light expressed by deteriorated pixels;

FIG. 6 is a graph illustrating a wavelength spectrum of an ambient light, a wavelength spectrum of a mixed light expressed by non-deteriorated pixels, and a wavelength spectrum of a mixed light expressed by deteriorated pixels;

FIG. 7 is a graph a wavelength spectrum of a mixed light expressed by deteriorated pixels and a wavelength spectrum in which a wavelength spectrum of an ambient light is reflected in the wavelength spectrum of the mixed light expressed by the deteriorated pixels;

FIG. 8 is a block diagram illustrating another example of the ambient light sensor and the image sticking compensator of FIG. 1;

FIG. 9 is a flowchart illustrating a method of compensating an image sticking in a display device according to embodiments of the present invention;

FIG. 10 is a block diagram illustrating an electronic device; and

FIG. 11 is a diagram illustrating an embodiment in which the electronic device of FIG. 10 is implemented as a smart phone.

### DETAILED DESCRIPTION

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Hereinafter, the present invention will be described in more detail with reference to the accompanying drawings.

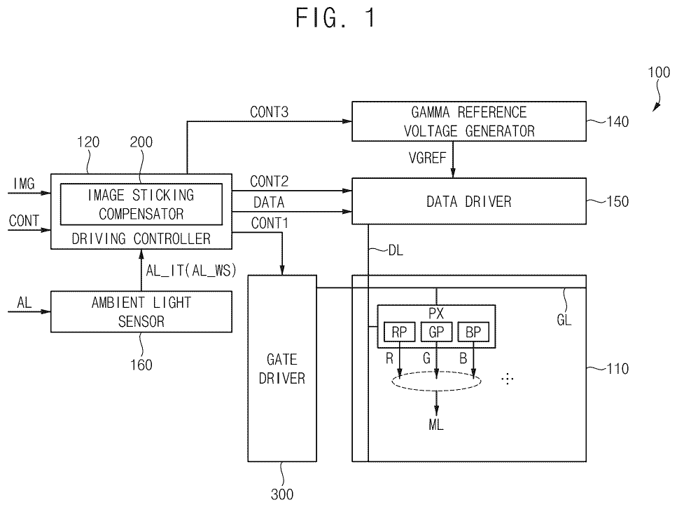

FIG. 1 is a block diagram illustrating a display device according to embodiments of the present invention.

Referring to FIG. 1, a display device 100 may include a display panel 110 and a display panel driver. The display panel driver may include a driving controller 120, a gate driver 130, a gamma reference voltage generator 140, a data driver 150, and an ambient light sensor 160.

The display panel 110 may include a display area for displaying an image and a peripheral area disposed adjacent to the display area.

The display panel 110 may include gate lines GL, data lines DL, pixels PX electrically connected to the gate lines GL and the data lines DL, respectively. The gate lines GL may extend in a first direction, and the data lines DL may extend in a second direction crossing the first direction.

Each of the pixels PX may include a red sub-pixel RP, a green sub-pixel GP, and a blue sub-pixel BP. The red sub-pixel RP may express a red light R, the green sub-pixel GP may express a green light G, and the blue sub-pixel BP may express a blue light B. A mixed light ML in which the red light R, the green light G, and the blue light B are mixed may express various colors. Therefore, the display panel 110 including the pixels PX may use the red sub-pixel RP, the green sub-pixel GP, and the blue sub-pixel BP to express the various colors.

The driving controller 120 may receive input image data IMG and an input control signal CONT from an external device (not shown). For example, the input image data IMG may include red image data, green image data and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 120 may generate a first control signal CONT1, a second control signal CONT2, a third control signal CONT3, and a data signal DATA based on the input image data IMG and the input control signal CONT.

The driving controller 120 may generate the first control signal CONT1 for controlling an operation of the gate driver 130 based on the input control signal CONT, and output the first control signal CONT1 to the gate driver 130. The first control signal CONT1 may include a vertical start signal and a gate clock signal.

The driving controller 120 may generate the second control signal CONT2 for controlling an operation of the data driver 150 based on the input control signal CONT, and output the second control signal CONT2 to the data driver 150. The second control signal CONT2 may include a horizontal start signal and a load signal.

The driving controller 120 may generate the data signal DATA based on the input image data IMG. The driving controller 120 may output the data signal DATA to the data driver 150.

The driving controller 120 may generate the third control signal CONT3 for controlling an operation of the gamma reference voltage generator 140 based on the input control signal CONT, and output the third control signal CONT3 to the gamma reference voltage generator 140.

The gate driver 130 may generate gate signals for driving the gate lines GL in response to the first control signal CONT1 received from the driving controller 120. The gate driver 130 may output the gate signals to the gate lines GL.

The gamma reference voltage generator 140 may generate a gamma reference voltage VGREF in response to the third control signal CONT3 received from the driving controller 120. The gamma reference voltage generator 140 may provide the gamma reference voltage VGREF to the data driver 150. The gamma reference voltage VGREF may have a value corresponding to each data signal DATA.

In an embodiment, the gamma reference voltage generator 140 may be disposed in the driving controller 120 or may be disposed in the data driver 150.

The data driver 150 may receive the second control signal CONT2 and the data signal DATA from the driving controller 120, and receive the gamma reference voltage VGREF from the gamma reference voltage generator 140. The data driver 150 may convert the data signal DATA into a data voltage having an analog type using the gamma reference voltage VGREF. The data driver 150 may output the data voltage to the data line DL.

The ambient light sensor 160 may sense an ambient light AL of the display panel 110. In an embodiment, the ambient light sensor 160 may sense an intensity AL_IT of the ambient light AL and provide the intensity AL_IT of the ambient light AL to the driving controller 120. In another embodiment, the ambient light sensor 160 may sense a wavelength spectrum AL_WS of the ambient light AL and provide the wavelength spectrum AL_WS of the ambient light AL to the driving controller 120.

The pixels PX may deteriorate depending on a use, and an image sticking may be perceived on the display panel 110 depending on an accumulated deterioration amount of the pixels PX. The accumulated deterioration amount may include a red accumulated deterioration amount, which is an accumulated deterioration amount of the red sub-pixel RP, a green accumulated deterioration amount, which is an accumulated deterioration amount of the green sub-pixel GP, and a blue accumulated deterioration amount, which is an accumulated deterioration amount of the blue sub-pixel BP.

Depending on a user's a usage environment, the red accumulated deterioration amount, the green accumulated deterioration amount, and the blue accumulated deterioration amount may be different from each other. Therefore, a luminance and a color of the image sticking may be different depending on the red accumulated deterioration amount, the green accumulated deterioration amount, and the blue accumulated deterioration amount. In addition, depending on the user's a surrounding environment, the ambient light AL of the display panel 110 may be different. Therefore, a luminance and a color of an image perceived by the user may be perceived differently depending on the ambient light AL of the display panel 110.

Therefore, the luminance and the color of the image perceived by the user may be different depending on the accumulated deterioration amount of the pixels PX and the ambient light AL. For example, even if the pixels PX are deteriorated and the pixels PX may not accurately express the red light R, when the ambient light AL is the red light R, the image perceived by the user may accurately express the red light R. Nevertheless, when the image sticking compensator 200 included in the driving controller 120 compensates the red light R, a display quality of the display device 100 may get worse. Therefore, in order to accurately express the luminance and the color of the image perceived by the user, the image sticking compensator 200 may need to perform an image sticking compensation operation considering the accumulated deterioration amount of the pixels PX and the ambient light AL.

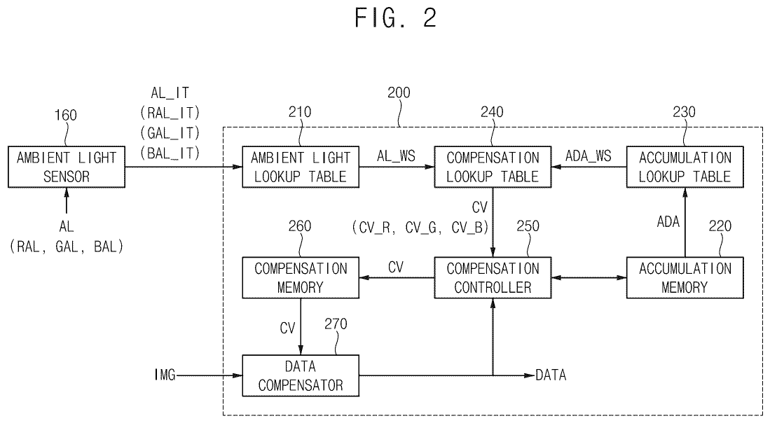

The image sticking compensation operation performed considering the accumulated deterioration amount of the pixels PX and the ambient light AL is specifically described below in FIGS. 2 to 8.

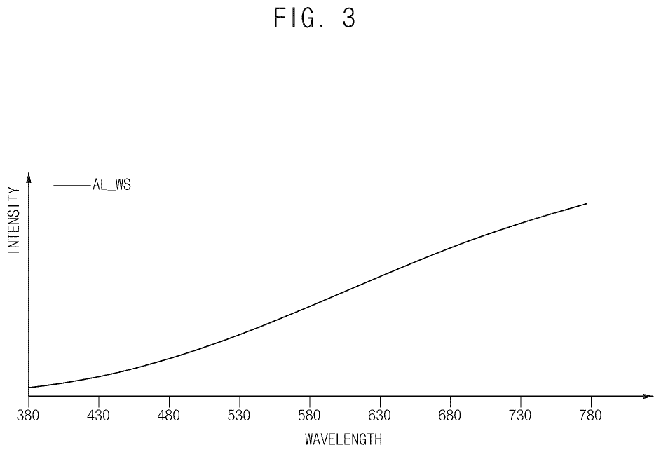

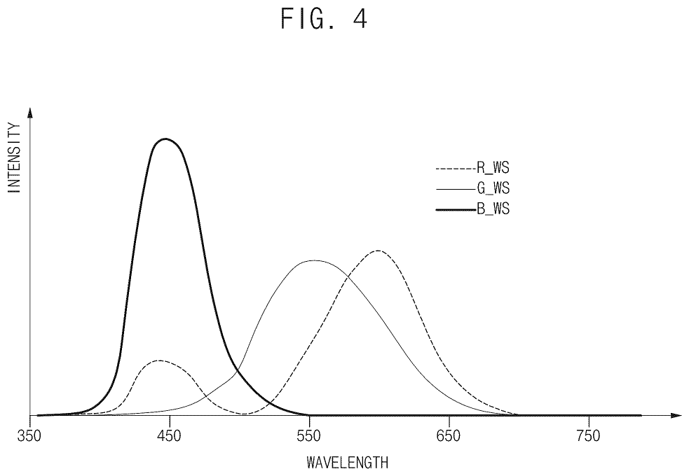

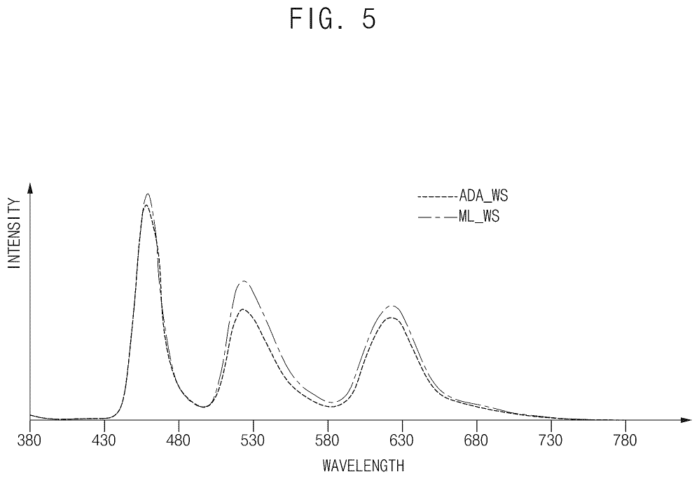

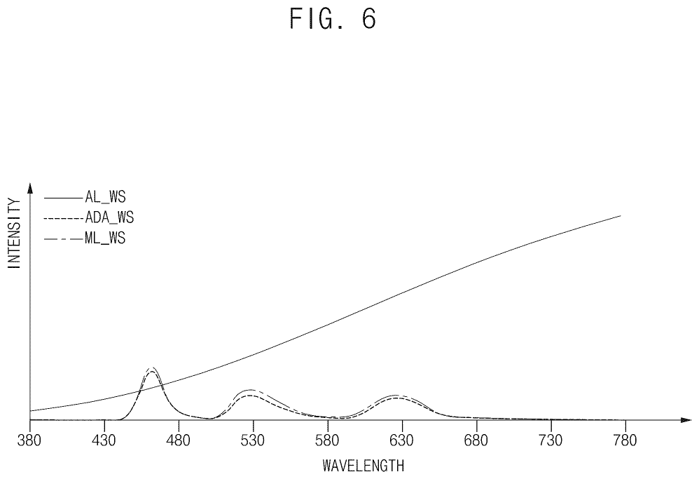

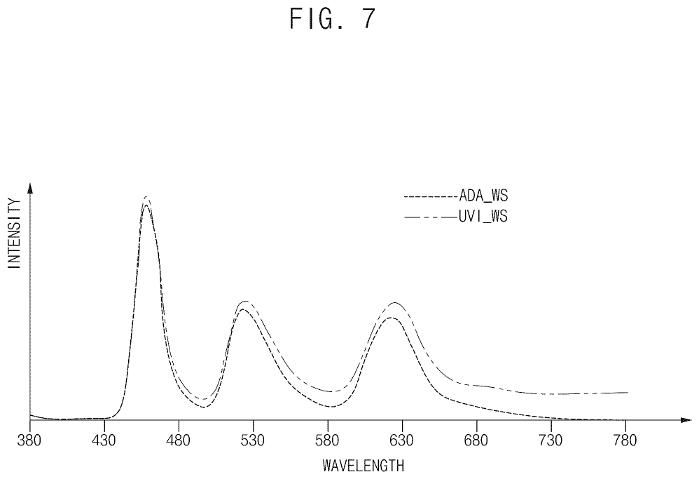

FIG. 2 is a block diagram illustrating an example of an ambient light sensor and an image sticking compensator of FIG. 1. FIG. 3 is a graph illustrating a wavelength spectrum of an ambient light. FIG. 4 is a graph illustrating wavelength spectrums of a red light, a green light, and a blue light expressed by pixels. FIG. 5 is a graph illustrating a wavelength spectrum of a mixed light expressed by non-deteriorated pixels and a graph illustrating a wavelength spectrum of a mixed light expressed by deteriorated pixels. FIG. 6 is a graph illustrating a wavelength spectrum of an ambient light, a wavelength spectrum of a mixed light expressed by non-deteriorated pixels, and a wavelength spectrum of a mixed light expressed by deteriorated pixels. FIG. 7 is a graph a wavelength spectrum of a mixed light expressed by deteriorated pixels and a wavelength spectrum in which a wavelength spectrum of an ambient light is reflected in the wavelength spectrum of the mixed light expressed by the deteriorated pixels.

Referring to FIGS. 1 to 7, a display device 100 may include an ambient light sensor 160 and an image sticking compensator 200. The ambient light sensor 160 may sense an ambient light AL of a display panel 110. The image sticking compensator 200 may generate a wavelength spectrum AL_WS of the ambient light AL based on the ambient light AL of the display panel 110, generate a wavelength spectrum ADA_WS of an accumulated deterioration amount ADA of pixels PX based on the accumulated deterioration amount ADA of pixels PX, and compensate an input image data IMG based on the wavelength spectrum AL_WS of the ambient light AL and the wavelength spectrum ADA_WS of the accumulated deterioration amount ADA.

In an embodiment, the ambient light sensor 160 may be an illuminance sensor, and the ambient light sensor 160 may sense the intensity AL_IT of the ambient light AL and provide sense the intensity AL_IT of the ambient light AL to the image sticking compensator 200. For example, the ambient light AL may include a red ambient light RAL, a green ambient light GAL, and a blue ambient light BAL, and the ambient light sensor 160 may sense an intensity RAL_IT of the red ambient light RAL, an intensity GAL_IT of the green ambient light GAL, an intensity BAL_IT of the blue ambient light BAL and provide the intensity RAL_IT of the red ambient light RAL, the intensity GAL_IT of the green ambient light GAL, the intensity BAL_IT of the blue ambient light BAL to the image sticking compensator 200.

The image sticking compensator 200 may include an ambient light lookup table 210, an accumulation memory 220, an accumulation lookup table 230, a compensation lookup table 240, a compensation controller 250, a compensation memory 260, and a data compensator 270.

The ambient light lookup table 210 may generate the wavelength spectrum AL_WS of the ambient light AL based on the intensity AL_IT of the ambient light AL. For example, the ambient light lookup table 210 may generate the wavelength spectrum AL_WS of the ambient light AL mixed with the red ambient light RAL, the green ambient light GAL, and the blue ambient light BAL based on the intensity RAL_IT of the red ambient light RAL, the intensity GAL_IT of the green ambient light GAL, and the intensity BAL_IT of the blue ambient light BAL.

For example, as shown in FIG. 3, in the wavelength spectrum AL_WS of the ambient light AL, as a wavelength increases, an intensity increases, and the wavelength spectrum AL_WS of the ambient light AL may have a large intensity at a wavelength of 780 nm.

The accumulation memory 220 may store the accumulated deterioration amount ADA of the pixels PX. Since the accumulated deterioration amount ADA of the pixels PX indicates a degree of a deterioration of the pixels PX, the accumulation memory 220 may be a non-volatile memory such that the accumulated deterioration amount ADA of the pixels PX is not erased even when the display device 100 is turned off. In an embodiment, the accumulation memory 220 may be implemented as a flash memory, but the present invention is not limited thereto. For example, each of the pixels PX may include a red sub-pixel RP, a green sub-pixel GP, and a blue sub-pixel BP, and the accumulated deterioration amount ADA may include the red accumulated deterioration amount, the green accumulated deterioration amount, and the blue accumulated deterioration amount. The accumulation memory 220 may provide the accumulated deterioration amount ADA of the pixels PX to the accumulation lookup table 230.

The accumulation lookup table 230 may generate the wavelength spectrum ADA_WS of the accumulated deterioration amount ADA based on the accumulated deterioration amount ADA of the above-described pixels PX. For example, the accumulation lookup table 230 may generate the wavelength spectrum ADA_WS of the accumulated deterioration amount ADA based on the red accumulated deterioration amount, the green accumulated deterioration amount, and the blue accumulated deterioration amount. Here, the wavelength spectrum ADA_WS of the accumulated deterioration amount ADA means a wavelength spectrum of a mixed light ML expressed by deteriorated pixels PX.

For example, when the red sub-pixel RP, the green sub-pixel GP, and the blue sub-pixel BP are not deteriorated, the red sub-pixel RP may express a wavelength spectrum R_WS of a red light R, the green sub-pixel GP may express a wavelength spectrum G_WS of a green light G, and the blue sub-pixel BP may express a wavelength spectrum B_WS of a blue light B, as shown in FIG. 4. For example, when the red sub-pixel RP, the green sub-pixel GP, and the blue sub-pixel BP are not deteriorated, a wavelength spectrum ML_WS of a mixed light ML in which the red light R, the green light G, and the blue light B are mixed may be expressed, as shown in FIG. 5. However, when the red sub-pixel RP, the green sub-pixel GP, and the blue sub-pixel BP are deteriorated, the wavelength spectrum ADA_WS of the accumulated deterioration amount ADA may be expressed, as shown in FIG. 5.

The compensation lookup table 240 may generate a compensation value CV of the pixels PX for compensating the input image data IMG based on the wavelength spectrum AL_WS of the ambient light AL and the wavelength spectrum ADA_WS of the accumulated deterioration amount ADA.

For example, as shown in FIG. 6, the compensation lookup table 240 may compare the wavelength spectrum AL_WS of the ambient light AL, the wavelength spectrum ADA_WS of the accumulated deterioration amount ADA, and the wavelength spectrum ML_WS of the mixed light ML. The wavelength spectrum ML_WS of the mixed light ML may be a reference wavelength spectrum, which is a wavelength spectrum of an image ultimately desired to be perceived by the user. In other words, the reference wavelength spectrum may a target wavelength spectrum to be perceived by the user.

In order to generate the compensation value CV of the pixels PX, it is important to know a luminance of a color of an image perceived by a user before the image sticking compensator 200 performs an image sticking compensation operation on the pixels PX. For example, as shown in FIG. 7, the compensation lookup table 240 may generate the wavelength spectrum UVI_WS of the image perceived by the user by applying the wavelength spectrum AL_WS of the ambient light AL to the wavelength spectrum ADA_WS of the accumulated deterioration amount ADA.

The compensation lookup table 240 may compare the wavelength spectrum UVI_WS of the image perceived by the user with the wavelength spectrum ML_WS of the mixed light ML to calculate a final accumulated deterioration amount of the pixels PX. The final accumulated deterioration amount of the pixels PX may be calculated using a Color Matching Function (“CMF”) based on the wavelength spectrum UVI_WS of the image perceived by the user and the wavelength spectrum ML_WS of the mixed light ML. The final accumulated deterioration amount of the pixels PX may include a final accumulated deterioration amount of the red sub-pixel RP, a final accumulated deterioration amount of the green sub-pixel GP, and a final accumulated deterioration amount of the blue sub-pixel BP.

The compensation lookup table 240 may generate a compensation value CV of the pixels PX based on the final accumulated deterioration amount of the pixels PX. The compensation value CV of the pixels PX may include a compensation value of the red sub-pixel RP, a compensation value of the green sub-pixel GP, and a compensation value of the blue sub-pixel BP. The compensation lookup table 240 may provide the compensation value CV of the pixels PX to the compensation controller 250.

The compensation controller 250 may provide the compensation value CV of the pixels PX to the compensation memory 260. The compensation memory 260 may store the compensation value CV of the pixels PX. The compensation memory 260 may be a volatile memory. The compensation memory 260 may provide the compensation value CV of the pixels PX to the data compensator 270.

The data compensator 270 may apply the compensation value CV of the pixels PX to the input image data IMG to generate a data signal DATA.

In addition, the compensation controller 250 may generate a current deterioration amount of a current frame based on the data signal DATA. The compensation controller 250 may receive an accumulated deterioration amount of a previous frame from the accumulation memory 220. The compensation controller 250 may accumulating the current deterioration amount of the current frame to the accumulated deterioration amount of the previous frame to generate the accumulated deterioration amount of the current frame. The compensation controller 250 may provide the accumulated deterioration amount of the current frame to the accumulation memory 220. Therefore, the accumulated deterioration amount ADA of the pixels PX accumulated in the accumulation memory 220 may be the accumulated deterioration amount of the previous frame or the accumulated deterioration amount of the current frame.

In addition, each of the pixels PX may include a plurality of cells corresponding to the red sub-pixel RP, the green sub-pixel GP, and the blue sub-pixel BP. The cells may have their own characteristics. For example, an aperture ratio of each of the cells may be different, and thus a stress received by each of the cells may be different. Therefore, the input image data IMG may be additionally compensated according to the characteristics of the each of the cells.

As such, the input image data IMG may be compensated based on the wavelength spectrum AL_WS of the ambient light AL and the wavelength spectrum ADA_WS of the accumulated deterioration amount ADA. Accordingly, the input image data IMG may be compensated considering the luminance and the color of the image perceived by the user.

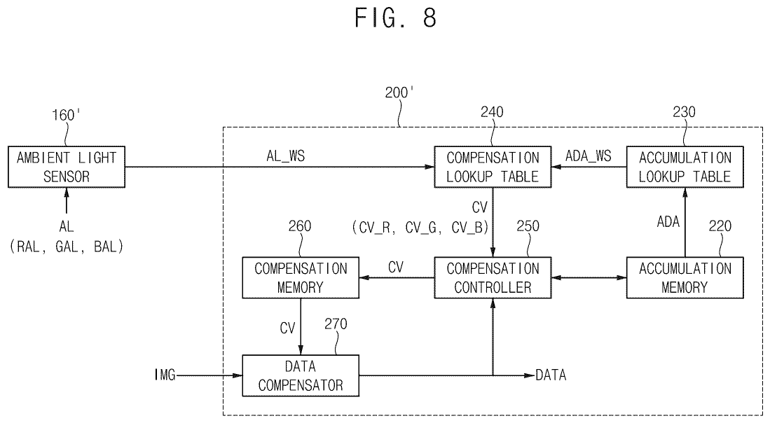

FIG. 8 is a block diagram illustrating another example of the ambient light sensor and the image sticking compensator of FIG. 1.

Referring to FIGS. 1 to 8, in an embodiment, an ambient light sensor 160′ of FIG. 8 may be a red-green-blue (“RGB”) spectrum sensor. The RGB spectrum sensor may sense the ambient light AL to generate the wavelength spectrum AL_WS of the ambient light AL and provide the wavelength spectrum AL_WS of the ambient light AL to the image sticking compensator 200′. That is, the operation performed by the ambient light sensor 160 and the ambient light lookup table 210 of FIG. 2 may be performed by the ambient light sensor 160′ of FIG. 8.

Except for this, the ambient light sensor 160′ and the image sticking compensator 200′ of FIG. 8 are substantially equal to the ambient light sensor 160 and the image sticking compensator 200 of FIG. 2. Therefore, the same reference numerals are used for the same or similar components, and redundant descriptions are omitted.

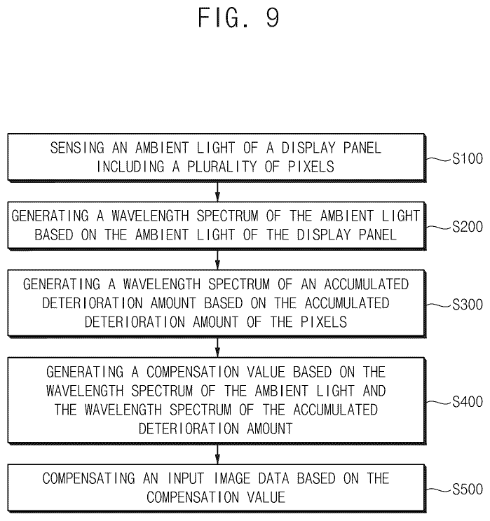

FIG. 9 is a flowchart illustrating a method of compensating an image sticking in a display device according to embodiments of the present invention.

Referring to FIGS. 1 to 9, a method of compensating an image sticking in a display device of FIG. 9 is substantially equal to a display device 100 of FIG. 1. Therefore, the same reference numerals are used for the same or similar components, and redundant descriptions are omitted.

The method of compensating the image sticking in the display device 100 according to embodiments of the present invention may include sensing an ambient light AL of a display panel 110 including a plurality of pixels PX (step S100), generating a wavelength spectrum AL_WS of the ambient light AL based on the ambient light AL of the display panel 110 (step S200), generating a wavelength spectrum ADA_WS of the accumulated deterioration amount ADA of the pixels PX based on the accumulated deterioration amount ADA of the pixels PX (step S300), and generating a compensation value CV based on the wavelength spectrum AL_WS of the ambient light AL and the wavelength spectrum ADA_WS of the accumulated deterioration amount ADA (step S400).

The step S100 may include generating an intensity RAL_IT of the red ambient light RAL, an intensity GAL_IT of the green ambient light GAL, and an intensity BAL_IT of the blue ambient light BAL. The step S200 may be performed based on the intensity RAL_IT of the red ambient light RAL, the intensity GAL_IT of the green ambient light GAL, and the intensity BAL_IT of the blue ambient light BAL. The step S300 may be performed based on the red accumulated deterioration amount, the green accumulated deterioration amount, and the blue accumulated deterioration amount. The step S400 may include generating a wavelength spectrum UVI_WS of an image perceived by a user by applying the wavelength spectrum AL_WS of the ambient light AL to the wavelength spectrum ADA_WS of the accumulated deterioration amount ADA, comparing the wavelength spectrum UVI_WS of the image perceived by the user with a reference wavelength spectrum, which is a target wavelength spectrum of the image to be perceived by the user, to generate a final accumulated deterioration amount of the pixels, and generating the compensation value CV of the pixels PX based on the final accumulated deterioration amount.

The method of compensating the image sticking in the display device 100 may further include compensating an input image data based IMG on the compensation value CV (step S500).

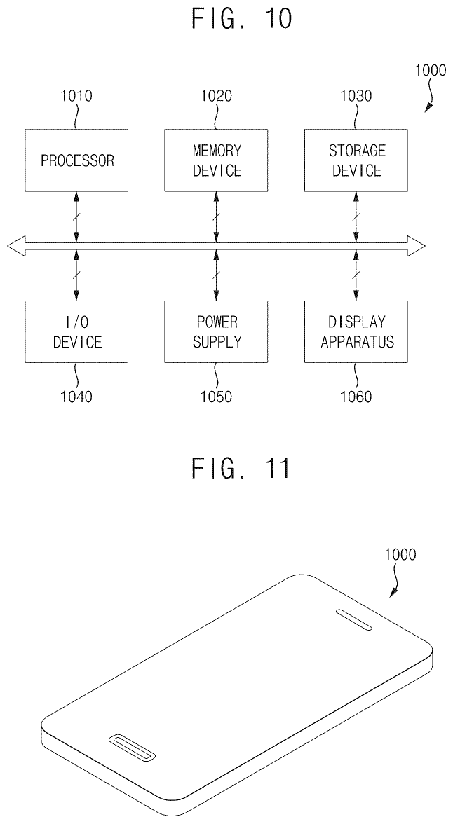

FIG. 10 is a block diagram illustrating an electronic device. FIG. 11 is a diagram illustrating an embodiment in which the electronic device of FIG. 10 is implemented as a smart phone.

Referring to FIGS. 10 and 11, the electronic device 1000 may include a processor 1010, a memory device 1020, a storage device 1030, an input/output (“I/O”) device 1040, a power supply 1050, and a display device 1060. The display device 1060 may be the display device 100 of FIG. 1. In addition, the electronic device 1000 may further include a plurality of ports for communicating with a video card, a sound card, a memory card, a universal serial bus (“USB”) device, other electronic devices, and the like.

In an embodiment, as shown in FIG. 11, the electronic device 1000 may be implemented as the smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display (“HMD”) device, and the like.

The processor 1010 may perform various computing functions. The processor 1010 may be a microprocessor, a central processing unit (“CPU”), an application processor (“AP”), and the like. The processor 1010 may be coupled to other components via an address bus, a control bus, a data bus, and the like. Further, the processor 1010 may be coupled to an extended bus such as a peripheral component interconnection (“PCI”) bus.

The memory device 1020 may store data for operations of the electronic device 1000. For example, the memory device 1020 may include at least one nonvolatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, and the like and/or at least one volatile memory device such as a dynamic random access memory (“DRAM”) device, a static random access memory (“SRAM”) device, a mobile DRAM device, and the like.

The storage device 1030 may include a solid state drive (“SSD”) device, a hard disk drive (“HDD”) device, a CD-ROM device, and the like.

The I/O device 1040 may include an input device such as a keyboard, a keypad, a mouse device, a touchpad, a touchscreen, and the like, and an output device such as a printer, a speaker, and the like. In some embodiments, the I/O device 1040 may include the display device 1060.

The power supply 1050 may provide power for operations of the electronic device 1000.

The display device 1060 may be connected to other components through buses or other communication links.

As used in connection with various embodiments of the disclosure, each of the ambient light lookup table 210, the accumulation lookup table 230, a compensation lookup table 240, the compensation controller 250, and the data compensator 270 may be implemented in hardware, software, or firmware, for example, implemented in a form of an application-specific integrated circuit (ASIC).

Various embodiments as set forth herein may be implemented as software including one or more instructions that are stored in a storage medium (e.g., a memory) that is readable by a machine (e.g., an electronic device). For example, a processor (e.g., a processor) of the machine (e.g., an electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

The inventions may be applied to any display device and any electronic device including the touch panel. For example, the inventions may be applied to a mobile phone, a smart phone, a tablet computer, a digital television (“TV”), a 3D TV, a personal computer (“PC”), a home appliance, a laptop computer, a personal digital assistant (“PDA”), a portable multimedia player (“PMP”), a digital camera, a music player, a portable game console, a navigation device, etc.

The foregoing is illustrative of the invention and is not to be construed as limiting thereof. Although a few embodiments of the invention have been described, those skilled in the art will readily appreciate that many modifications are possible in the embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A display device, comprising:
a display panel including a plurality of pixels;
an ambient light sensor configured to sense an ambient light of the display panel; and
an image sticking compensator configured to perform an image sticking compensation operation on the pixels,
wherein the image sticking compensator includes:
an accumulation lookup table configured to generate a wavelength spectrum of an accumulated deterioration amount of the pixels based on the accumulated deterioration amount of the pixels; and
a compensation lookup table configured to generate a compensation value of the pixels for compensating an input image data based on a wavelength spectrum of the ambient light and the wavelength spectrum of the accumulated deterioration amount,
wherein an ambient light lookup table included in the image sticking compensator or the ambient light sensor is configured to generate the wavelength spectrum of the ambient light based on the ambient light of the display panel.

2. The display device of claim 1, wherein the image sticking compensator further includes:
an accumulation memory configured to store the accumulated deterioration amount of the pixels.

3. The display device of claim 2, wherein the image sticking compensator further includes:
a compensation memory configured to store the compensation value; and
a data compensator configured to compensate the input image data based on the compensation value.

4. The display device of claim 1, wherein the ambient light includes a red ambient light, a green ambient light, and a blue ambient light, and
wherein the ambient light sensor is configured to sense the ambient light to generate an intensity of the red ambient light, an intensity of the green ambient light, and an intensity of the blue ambient light and provide the intensity of the red ambient light, the intensity of the green ambient light, and the intensity of the blue ambient light to the ambient light lookup table.

5. The display device of claim 4, wherein the ambient light lookup table is configured to generate the wavelength spectrum of the ambient light based on the intensity of the red ambient light, the intensity of the green ambient light, and the intensity of the blue ambient light.

6. The display device of claim 1, wherein each of the pixels includes a red sub-pixel, a green sub-pixel, and a blue sub-pixel, and
wherein the accumulated deterioration amount includes a red accumulated deterioration amount which is an accumulated deterioration amount of the red sub-pixel, a green accumulated deterioration amount which is an accumulated deterioration amount of the green sub-pixel, and a blue accumulated deterioration amount which is an accumulated deterioration amount of the blue sub-pixel.

7. The display device of claim 6, wherein the accumulation lookup table is configured to generate the wavelength spectrum of the accumulated deterioration amount based on the red accumulated deterioration amount, the green accumulated deterioration amount, and the blue accumulated deterioration amount.

8. The display device of claim 1, wherein the compensation lookup table is configured to generate a wavelength spectrum of an image perceived by a user by applying the wavelength spectrum of the ambient light to the wavelength spectrum of the accumulated deterioration amount.

9. The display device of claim 8, wherein the compensation lookup table is configured to compare the wavelength spectrum of the image perceived by the user with a reference wavelength spectrum, which is a target wavelength spectrum of the image to be perceived by the user, to generate a final accumulated deterioration amount of the pixels, and generate the compensation value of the pixels based on the final accumulated deterioration amount.

10. The display device of claim 1, wherein the ambient light sensor is an illuminance sensor.

11. The display device of claim 1, wherein the ambient light sensor is an RGB spectrum sensor and configured to generate the wavelength spectrum of the ambient light based on the ambient light of the display panel.

12. The display device of claim 1, wherein each of the pixels includes a plurality of cells, and the input image data is additionally compensated according to a characteristics of each of the cells.

13. A method of compensating an image sticking in a display device, comprising:
sensing an ambient light of a display panel including a plurality of pixels;
generating a wavelength spectrum of the ambient light based on the ambient light of the display panel;
generating a wavelength spectrum of an accumulated deterioration amount of the pixels based on the accumulated deterioration amount of the pixels; and
generating a compensation value of the pixels based on the wavelength spectrum of the ambient light and the wavelength spectrum of the accumulated deterioration amount.

14. The method of claim 13, further comprising:
compensating an input image data based on the compensation value.

15. The method of claim 13, wherein the ambient light includes a red ambient light, a green ambient light, and a blue ambient light, and
wherein the sensing of the ambient light comprises generating an intensity of the red ambient light, an intensity of the green ambient light, and an intensity of the blue ambient light.

16. The method of claim 15, wherein the generating of the wavelength spectrum of the ambient light is performed based on the intensity of the red ambient light, the intensity of the green ambient light, and the intensity of the blue ambient light.

17. The method of claim 13, wherein each of the pixels includes a red sub-pixel, a green sub-pixel, and a blue sub-pixel, and
wherein the accumulated deterioration amount includes a red accumulated deterioration amount which is an accumulated deterioration amount of the red sub-pixel, a green accumulated deterioration amount which is an accumulated deterioration amount of the green sub-pixel, and a blue accumulated deterioration amount which is an accumulated deterioration amount of the blue sub-pixel.

18. The method of claim 17, wherein the generating of the wavelength spectrum of the accumulated deterioration amount is performed based on the red accumulated deterioration amount, the green accumulated deterioration amount, and the blue accumulated deterioration amount.

19. The method of claim 13, wherein the generating of the compensation value comprises generating a wavelength spectrum of an image perceived by a user by applying the wavelength spectrum of the ambient light to the wavelength spectrum of the accumulated deterioration amount.

20. The method of claim 19, wherein the generating of the compensation value further comprises:
comparing the wavelength spectrum of the image perceived by the user with a reference wavelength spectrum, which is a target wavelength spectrum of the image to be perceived by the user, to generate a final accumulated deterioration amount of the pixels, and
generating the compensation value of the pixels based on the final accumulated deterioration amount.

21. An electronic device, comprising:
a display panel including a plurality of pixels;
an ambient light sensor configured to sense an ambient light of the display panel;
an image sticking compensator configured to perform an image sticking compensation operation on the pixels; and
a power supply configured to provide a power to the display panel, the ambient light sensor, and the image sticking compensator,
wherein the image sticking compensator includes:
an accumulation lookup table configured to generate a wavelength spectrum of an accumulated deterioration amount of the pixels based on the accumulated deterioration amount of the pixels; and
a compensation lookup table configured to generate a compensation value of the pixels for compensating an input image data based on a wavelength spectrum of the ambient light and the wavelength spectrum of the accumulated deterioration amount,
wherein an ambient light lookup table included in the image sticking compensator or the ambient light sensor is configured to generate the wavelength spectrum of the ambient light based on the ambient light of the display panel.
